(19) United States
(12) Patent Application Publication
(10) Pub. No.: US 2012/0148843 A1
(43) Pub. Date: Jun. 14, 2012

(54) DURABLE HIGHLY CONDUCTIVE SYNTHETIC FABRIC CONSTRUCTION

(75) Inventors: Mark Levine, Hendersonville, TN (US); Joseph G. O'Connor, Hopedale, MA (US); Frank DiTaranto, Norton, MA (US); Crayton Gregory Toney, Wrentham, MA (US); Shuiyuan Luo, Syracuse, NY (US)

(73) Assignee: Albany International Corp., Albany, NY (US)

(21) Appl. No.: 13/400,954

(22) Filed: Feb. 21, 2012

Related U.S. Application Data
(63) Continuation of application No. 10/699,997, filed on Nov. 3, 2003, now abandoned.

(51) Int. Cl. B32B 27/02

(52) U.S. Cl. 428/394

(57) ABSTRACT

A fabric is provided comprising functional filaments, wherein each filament contains electrically conductive polymer material. In this way, the fabric is made conductive and has static dissipation properties comparable to metal-based fabrics. At the same time, the fabric also has desirable physical properties comparable to non-conductive synthetic fabrics.

This application is a continuation of U.S. patent application Ser. No. 10/699,997 filed Nov. 3, 2003, the entire disclosure of which is incorporated herein by reference.

### FIELD OF THE INVENTION

The present invention is directed towards a conductive fabric construction, particularly one that effectively dissipates static charge whilst also having desirable physical properties.

### BACKGROUND OF THE INVENTION

Heretofore, conductive fabrics useful for, as an example, dissipation of static electricity, have incorporated monofilaments with high loadings of conductive materials, such as carbon black or metallic particulate. Typically, these conductive materials are either dispersed within a base polymer, such as polyethylene terephthalate and polyamide, or incorporated in polymeric coatings which are deposited over oriented monofilaments.

There are several limitations associated with these prior art methods. First, the conductivity of the loaded monofilaments is only in the range of 10⁻⁴−10⁻⁷ S/cm, which is the bare minimum needed for effective dissipation of static charge. Unfortunately, this drawback limits the fabric design options, and also impairs fabric performance. A second disadvantage is that, in the case of fully filled products, there is a compromise of monofilament physical properties, such as modulus, tenacity and elongation. This is due to the high level of contamination caused by compounding levels greater than twenty percent of the conductive filler. This loss of physical properties, again, restricts the options for fabric design and negatively impacts fabric performance. A further shortcoming associated with prior art conductive fabrics is that highly loaded carbon-based coatings exhibit both poor abrasion and inferior adhesion properties. Consequently, the fabric's durability along with its dissipation properties both suffer.

Other prior art conductive fabrics incorporate conductive coatings, metallic wire constructions, or combination designs incorporating metallic additive fibers within a synthetic structure. There are, however, drawbacks also associated with these fabrics. For example, while these prior designs may dissipate static charge, it is noted that structures with metallic wires are difficult to manufacture. A further disadvantage is that metal-based fabrics are easily damaged, and in particular, incur unwanted dents and creases during use. Prior art coated designs, on the other hand, have suffered from a lack of durability and also interfere with the permeability of open mesh structures.

The incorporation of electrically conductive polymers into fabrics presents a potential solution to the forgoing problems. In this connection, conductive polymers are available either as the polymer itself or a doped form of a conjugated polymer. Additionally, conductivities as high as 30-35×10³ S/cm have been achieved using these polymers, which is only an order of magnitude below the conductivity of copper. However, in addition to being sufficiently conductive, the polymer must also be stable in air at use temperature and so retain its conductivity over time. Also, the conductive polymer material must be processable, and have sufficient mechanical properties for a particular application.

### SUMMARY OF THE INVENTION

It is therefore a principal object of the invention to incorporate conductive polymers into forms that can be manufactured into durable fabric constructions.

This and other objects and advantages are provided by the present invention. In this regard, the present invention is directed towards a durable, highly conductive, synthetic fabric construction. Advantageously, the invention involves using functional filaments containing conductive polymer material. As a result, synthetic fabrics comprised of these conductive filaments have static dissipation properties previously available only in metal-based fabrics, whilst also having physical properties comparable to non-conductive fabrics. Consequently, the inventive fabric construction resists the denting and creasing associated with metallic fabric designs.

### BRIEF DESCRIPTION OF THE DRAWING

Thus by the present invention, its objects and advantages will be realized the description of which should be taken in conjunction with the drawing wherein:

FIG. 1 is a cross sectional view of a lobed monofilament coated with an electrically conductive polymer, according to the teachings of the present invention.

### DETAILED DESCRIPTION OF THE PREFERRED EMBODIMENTS

A preferred embodiment of the present invention will be described in the context of engineered fabrics, such as fabrics used in making non-woven textiles in the airlaid, meltblown and/or spunbonding processes. However, it should be noted that the invention is also applicable to other industrial fabrics used in any “dry” applications where the dissipation of static electricity is required, for instance, through the belting media. Fabric constructions include woven, nonwoven, spiral-link, MD or CD yarn arrays, knitted fabric, extruded mesh, and spiral wound strips of woven and nonwoven materials. These fabrics may comprise monofilament, plied monofilament, multifilament or plied multifilament synthetic yarns, and may be single-layered, multi-layered or laminated.

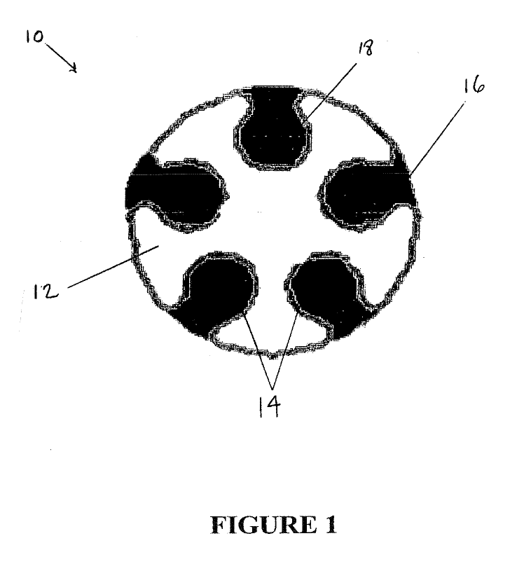

Turning now more particularly to the drawing, the invention provides for fabrics comprising, as shown in FIG. 1 (cross sectional view), functional filament(s) 10 containing electrically conductive polymer material 14. Thus, whereas conductive polymers by themselves generally lack the strength to be formed into load bearing filaments 10, the invention incorporates these conductive materials 14 as either blends or coatings in conjunction with polymeric materials that can be oriented to achieve physical properties needed to form durable fabric structures. Advantageously, fabrics incorporating at least five percent of these conductive filaments 10 have static dissipation properties equivalent to, and previously available only in, metal-based fabrics, whilst possessing physical properties equivalent to non-conductive fabrics. Consequently, fabrics with these filaments 10 resist the denting and creasing heretofore associated with metal designs.

In particular, the invention incorporates the conductive polymer 14 as blends into monofilaments 12 having sufficient thermal stability. Alternatively, the invention envisions bicomponent fibers containing the conductive polymer 14 and produced using melt extrusion. As a further option, FIG. 1 illustrates a preferred embodiment wherein the conductive polymer 14 is applied to the monofilament 12 as a coating. Techniques include, for example, dip coating, spraying from solutions, dispersions over oriented monofilaments, thermal spraying, or other means suitable for the purpose. Notably, there is at least one class of conductive polymers, polyanilines, from which filaments have been produced with high conductivities and physical properties comparable to polyamides. Accordingly, the invention provides for using these conductive filaments directly in fabrics.

The embodiment shown cross sectionally in FIG. 1 provides for coating a lobed monofilament 12 with the conductive polymer material 14. Advantageously, this increases the monofilament's conductivity beyond 10⁻³ S/cm (preferably beyond 10³ S/cm), whilst maintaining the monofilament's physical and tribological properties. As a further benefit, the surface 16 of the monofilament 12 has a plurality of C-shaped grooves 18 running along the length thereof, and these grooves 18 may be formed during the extrusion of the monofilament 12. Consequently, a mechanical interlock forms between the monofilament 12 and the polymer material 14 filling the grooves 18. This configuration thus reduces the need for adhesion of the polymer 14 to the monofilament 12. As a further advantage, this arrangement allows continued exposure of the highly conductive polymer 14 to the surface 16 even as the monofilament 12 wears, whilst also shielding and protecting the polymer material 14. In addition the protective positioning of the conductive polymer 14 reduces the impact of the polymer's lesser abrasion resistance and physical properties.

A yet further benefit of the invention is that the weight percent composition of the conductive polymer 14 can be only ten percent or less of the filament 10. This keeps fabric production costs down while providing effective dissipation of the static charge. In this connection, classes of conductive polymers 14 that can be used include: polyacetylene (PA), polythiophene (PT), poly3alkyl-thiophene) (P3AT), polypyrrole (Ppy), polyisothianaphthene (PITN), polyethylene dioxythio-phene (PEDOT), alkoxy-substituted poly(para-phenylene vinylene) (PPV), poly(para-phenylene vinylene) (PPV), poly(2,5-dialkoxy-para-phenylene), poly(para-phenylene) (PPP), ladder-type poly(para-phenylene) (LPPP), poly(para-phenylene) sulfide (PPS), polyheptadiyne(PHT), poly(3-hexyl thiophene) (P3HT), polyaniline (PANI).

Thus by the present invention its objects and advantages are realized, and although preferred embodiments have been disclosed and described in detail herein, its scope and objects should not be limited thereby; rather its scope should be determined by that of the appended claims.

What is claimed is:

1. A conductive engineered industrial belting media suitable for making nonwoven textiles in the airlaid, meltblown or spunbonding processes comprising a plurality of load-hearing oriented polymeric filaments having one or more shaped grooves formed on the surface of the filaments, wherein each filament includes electrically conductive polymer material incorporated as either a blend or a coating that substantially fills the shaped grooves, wherein the cross-section of each shaped groove presents a shape that provides a mechanical interlock between a monofilament and the conductive polymer, said conductive fabric having static dissipation properties comparable to metal-based belting media whilst being resistant to dents and creases and wherein the one or more shaped grooves allow for continued exposure of the conductive polymer to the filament surface as the monofilament wears so that the filament retains its conductivity.

2. The industrial belting media in accordance with claim 1, wherein the functional filaments constitute between five and one hundred percent of the fabric.

3. The industrial belting media in accordance with claim 1, wherein the fabric has static dissipation properties equivalent to metal-based fabrics whilst also having physical properties comparable to non-conductive synthetic fabrics.

4. The industrial belting media in accordance with claim 3, wherein said physical properties include one of modulus, tenacity, strength, adhesion, abrasion resistance, and durability.

5. The industrial belting media in accordance with claim 1, wherein the filament comprises conductive polymer material blended with polymeric materials that can be oriented.

6. The industrial belting media in accordance with claim 1, wherein the filament is a bicomponent fiber containing conductive polymer material and formed by melt extrusion.

7. The industrial belting media in accordance with claim 1, wherein the filament comprises an oriented structure coated with conductive polymer material.

8. The industrial belting media in accordance with claim 7, wherein the conductive polymer is applied by one of dip coating, spraying from solutions, dispersion over the filament, and thermal spraying.

9. The fabric in accordance with claim 1, wherein the filament comprises conductive polymer material selected from the class of polyanilines.

10. The industrial belting media in accordance with claim 9, wherein said polyaniline filament has physical properties comparable to a polyamide filament.

11. The industrial belting media in accordance with claim 1, wherein the filament is a lobed monofilament coated with conductive polymer material.

12. The industrial belting media in accordance with claim 11, wherein the coating has a conductivity, minimally greater than 10⁻³ S/cm, whilst maintaining the physical and tribological properties of the core monofilament.

13. The industrial belting media in accordance with claim 11, wherein the shape of the one or more shaped grooves includes C-shaped grooves that provide a mechanical interlock between the monofilament and the conductive polymer filling the grooves.

14. The industrial belting media in accordance with claim 13, wherein the interlock provided by the C-shaped grooves reduces a need for adhesion of the conductive polymer to the monofilament by providing the mechanical interlock between the monofilament and the conductive polymer filling the grooves.

15. The industrial belting media in accordance with claim 13, wherein positioning of the conductive polymer in the C-shaped grooves shields the polymer and reduces the impact of its lesser abrasion resistance and physical properties.

16. The industrial belting media in accordance with claim 11, wherein the weight composition of the conductive material is ten percent or less of the total weight of the coated monofilament.

17. The industrial belting media in accordance with claim 1, wherein the fabric is single layered or multi layered, or laminated.

18. The fabric in accordance with claim 1, wherein the fabric is one of woven, nonwoven, spiral-link, MD or CD yarn arrays, knitted fabric, extruded mesh, and spiral wound strips of woven and non-woven materials.

19. The industrial belting media in accordance with claim 1, wherein the fabric is used in a dry application in which static dissipation is required through the belting media.

20. The industrial belting media in accordance with claim 1, wherein the conductive polymer is one of polyacetylene, polythiophene, poly3alkyl-thiophene, polypyrrole, poly-isothianaphthene, polyethylene dioxythiophene, alkoxy-substituted poly(para-phenylene vinylene), poly(para-phenylene vinylene), poly(2,5-dialkoxy-para-phenylene), poly(paraphenylene), ladder-type poly(para-phenylene), poly(para-phenylene) sulfide, polyheptadiyne, and poly(3-hexyl thiophene).

21. An engineered industrial belting media load bearing polymeric filament said polymeric filament having one or more shaped grooves formed on the surface of the filaments, wherein said shaped grooves are substantially filled with electrically conductive polymer material mechanically locked in place and wherein the one or more shaped grooves allow for continued exposure of the conductive polymer to the filament surface as the monofilament wears so that the filament retains its conductivity and wherein the cross-section of each shaped groove presents a shape that provides a mechanical interlock between the monofilament and the conductive polymer.

22. The filament in accordance with claim 21, wherein the filament comprises conductive polymer material blended with polymeric materials that can be oriented.

23. The filament in accordance with claim 21, wherein the filament is a bicomponent fiber containing conductive polymer material and formed by melt extrusion.

24. The filament in accordance with claim 21, wherein the filament comprises an oriented structure coated with conductive polymer material.

25. The filament in accordance with claim 24, wherein the conductive polymer is applied by one of dip coating, spraying from solutions, dispersion over the filament, and thermal spraying.

26. The filament (10) in accordance with claim 21, wherein the filament (10) comprises a conductive polymer material (14) selected from the class of polyanilines.

27. The filament in accordance with claim 26, wherein said polyaniline filament has physical properties comparable to a polyamide filament.

28. The filament in accordance with claim 21, wherein the filament is a lobed monofilament coated with conductive polymer material.

29. The filament in accordance with claim 28, wherein the coating has a conductivity, minimally greater than 10⁻³ S/cm, whilst maintaining the physical and tribological properties of the core monofilament.

30. The filament in accordance with claim 28, wherein the shape of the grooves includes C-shaped grooves that provide a mechanical interlock between the monofilament and the conductive polymer filling the grooves.

31. The filament in accordance with claim 30, wherein the interlock provided by the C-shaped grooves reduces a need for adhesion of the conductive polymer to the monofilament by providing the mechanical interlock between the monofilament and the conductive polymer filling the grooves.

32. The filament in accordance with claim 30, wherein positioning of the conductive polymer in the C-shaped grooves shields the polymer and reduces the impact of its lesser abrasion resistance and physical properties.

33. The filament in accordance with claim 28, wherein the weight composition of the conductive material is ten percent or less of the total weight of the coated monofilament.

34. The filament in accordance with claim 21, wherein the conductive polymer is one of polyacetylene, polythiophene, poly3alkyl-thiophene, polypyrrole, poly-isothia-naphthene, polyethylene dioxythiophene, alkoxy-substituted poly(para-phenylene vinylene), poly(para-phenylene vinylene), poly(2,5-dialkoxy-para-phenylene), poly(para-phenylene), ladder-type poly(para-phenylene), poly(para-phenylene) sulfide, polyheptadiyne, and poly(3-hexyl thiophene).

35. The industrial belting media in accordance with claim 11, wherein the coating has a conductivity greater than 10³ S/cm, whilst maintaining the physical and tribological properties of the core monofilament.

36. The filament in accordance with claim 28, wherein the coating has a conductivity greater than 10³ S/cm, whilst maintaining the physical and tribological properties of the core monofilament.

37. The industrial belting media in accordance with claim 1, wherein the industrial belting media is laminated.

38. The industrial belting media in accordance with claim 18, wherein the spiral wound strips are woven or nonwoven materials comprising yarns including monofilaments, plied monofilaments, multifilaments, plied multifilaments and staple fibers.

39. The industrial belting media in accordance with claim 1 wherein the monofilament has a non-circular cross sectional shape.

40. The industrial belting media in accordance with claim 39 wherein the monofilament has the non-circular cross sectional shape selected from the group of rectangular, square, trapezoidal, oblong, oval, conical, or star-shaped

41. The industrial belting media in accordance with claim 40 wherein the monofilament's the non-circular cross sectional shape is rectangular or square, and includes a plurality of grooves.

42. The filament in accordance with claim 21 wherein the monofilament has a non-circular cross sectional shape.

43. The filament in accordance in accordance with claim 42 wherein the monofilament has the non-circular cross sectional shape selected from the group of rectangular, square, trapezoidal, oblong, oval, conical, or star-shaped.

44. The filament in accordance with claim 43 wherein the monofilament's non-circular cross sectional shape is rectangular or square, and includes a plurality of grooves.

45. The industrial belting media in accordance with claim 11, wherein the shape of the one or more shaped grooves includes a necking that provides a mechanical interlock between the monofilament and the conductive polymer filling the grooves.

46. The filament in accordance with claim 21 wherein the shape of the one or more shaped grooves includes a necking that provides a mechanical interlock between the monofilament and the conductive polymer filling the grooves.
